(19) United States
(12) Patent Application Publication
(10) Pub. No.: US 2008/0015897 A1
(43) Pub. Date: Jan. 17, 2008

(54) METHOD AND SYSTEM FOR DELIVERING PRESCRIPTION MEDICINE

(76) Inventors: Ahmad Moradi, Ft. Lauderdale, FL (US); Donald Smith, Fountain Valley, CA (US); Farshad R. Abadi, Ft. Lauderdale, FL (US)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/773,709

(22) Filed: Jul. 5, 2007

Related U.S. Application Data
(63) Continuation of application No. 10/207,402, filed on Jul. 29, 2002.

(51) Int. Cl. G06Q 90/00

(52) U.S. Cl. 705/2

(57) ABSTRACT

A system for securely providing prescription medication to patients. The system accepts prescriptions that are submitted from either a physician's office or by the patient at a Kiosk. An electronic image of the prescription is created by scanning and is electronically communicated to a central server. The prescription is validated by the server and a point of delivery, such as a pharmacy is selected based upon the patient's location. The prescription image is then transferred to the point of delivery and the prescribed medicine is delivered to the patient. A confirmation of delivery is then communicated back to the central server.

### CROSS REFERENCE TO RELATED APPLICATIONS

This application is a continuation of U.S. patent application Ser. No. 10/207,402 filed Jul. 29, 2002, the entire content of which is incorporated herein by reference.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records but otherwise reserves all copyright rights whatsoever.

### BACKGROUND OF THE INVENTION

1. Field of the Invention

This invention generally relates to the field of prescription delivery systems, and more particularly to the field of automated prescription handling.

2. Description of the Related Art

Delivery of prescription medication has changed little in recent times. Conventional prescription medication delivery begins by a prescription being first issued by a physician and then the patient is required to present that prescription to a pharmacist. The pharmacist then prepares the prescribed medication and delivers it to the patient. This process requires the patient to visit the pharmacist and to either wait at the pharmacist's facility or to return to the pharmacist's facility when the prescription is ready. This is often inconvenient for the patient.

Delivery of prescription medication by mail is also possible. Current systems require the prescription to be provided to a pharmacy and the pharmacy then mails the medication. This technique has a delay in the initial fulfillment of a new prescription because the prescription is often mailed to the pharmacy, and there is also a delay in mailing the prescription. This technique is better used for prescription refills, including maintenance prescriptions that have routinely refilled prescriptions for medication for which the patient has a recurring therapeutic need. In the case of a refill prescription, there is usually time available to accommodate the delays of this technique. This technique is also open to fraud since the individual patient typically does not personally present his or her prescription to the pharmacy. This technique can also lead to an improper person receiving the prescription, such as when a child that is living with the recipient retrieves mail that contains the mailed prescription.

Self service medication dispensing Kiosks have been developed that give a patient greater flexibility in the delivery of prescribed medication. These Kiosks often contain an inventory of hundreds to over one thousand different types of prescribed medication. These Kiosk distribution systems can operate in conjunction with a mail order or Internet based “Cyber” pharmacy where the patient sends his or her prescription to the pharmacist by mail or electronically, including by facsimile or secure e-mail. The pharmacist then verifies the prescription and enters the prescription into a secure database that is used to authorize distribution of medication at one or more Kiosks. Some of these systems require the pharmacist to enter an identification to authenticate the pharmacist as a person authorized the distribute prescription medication. The patient that is to receive the prescribed medication is given a patient identification that the patient provides at the Kiosk in order to receive the prescribed medication. The patient enters his or her patient identification into the Kiosk and the Kiosk accesses the secure database to determine if there is a prescription associated with that patient ID. If there is, instructions to dispense the medication are retrieved from the database. After payment arrangements are made, the Kiosk uses these instructions to dispense the medication. After dispensing the medication, the secure database is updated to indicate that the medication was dispensed.

### SUMMARY OF THE INVENTION

Briefly, according to an aspect of the present invention, a method and system for delivering prescription medicine provides method of performing prescription medicine delivery that issues a prescription to a person and also accepts an identification of that person. The method then transmits a first set of data to a central server. This first set of data contains the accepted identification of the person and a representation of the prescription. The method then transmits a second set of data from the central server to a point of delivery. This second set of data is derived from the first set of data. The method then delivers the medicine that was prescribed by the prescription to the person.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a system architecture of an automatic prescription delivery system, in accordance with an exemplary embodiment of the present invention,

FIG. 2 is a software component diagram of an automatic prescription delivery system, in accordance with an exemplary embodiment of the present invention.

FIG. 3 is a top level processing flow diagram of an automatic prescription delivery system, in accordance with an exemplary embodiment of the present invention.

FIG. 4 is a view of the scanning area of an image scanner that is used to capture images for electronic transmission, in accordance with an exemplary embodiment of the present invention.

FIGS. 5A and 5B are a processing flow diagram for a point of care system of an automatic prescription delivery system, in accordance with an exemplary embodiment of the present invention.

FIG. 6 is a user logon processing flow diagram used by several components of an automatic prescription delivery system, in accordance with an exemplary embodiment of the present invention.

FIG. 7 is a processing flow diagram for registering a physician to use an automatic prescription delivery system, in accordance with an exemplary embodiment of the present invention.

FIG. 8 is a processing flow diagram for registering a patient to use an automatic prescription delivery system, in accordance with an exemplary embodiment of the present invention.

FIG. 9 is a processing flow diagram for registering a pharmacist to use an automatic prescription delivery system, in accordance with an exemplary embodiment of the present invention.

FIG. 10 is a processing flow diagram for a point of delivery system of an automatic prescription delivery system, in accordance with an exemplary embodiment of the present invention.

FIG. 11 is a processing flow diagram for processing automatic prescription refill data, in accordance with an exemplary embodiment of the present invention.

### DETAILED DESCRIPTION OF AN EMBODIMENT

Preferred embodiments of the present invention will be described in detail hereinbelow with reference to the attached drawings.

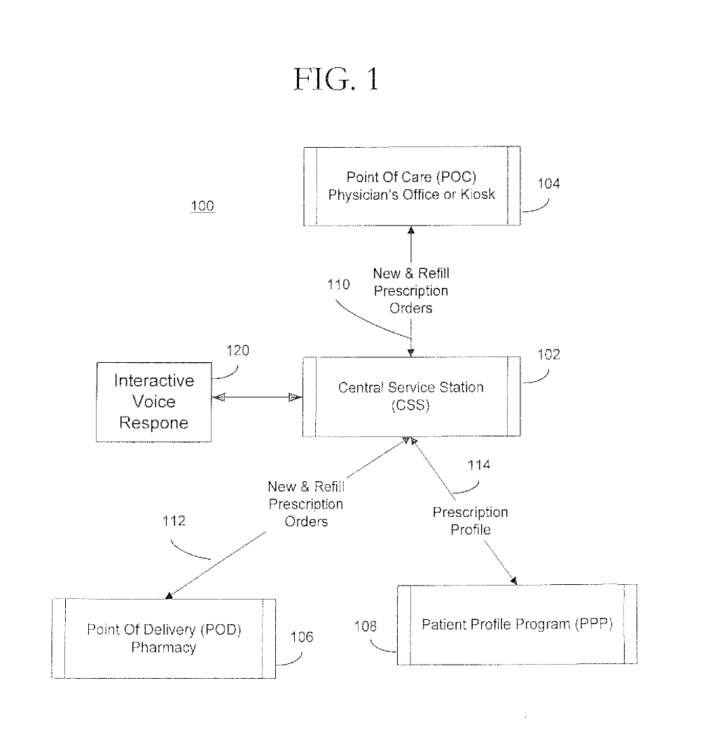

The present invention is embodied within a system designated by the trademark 3P.NET. An automated prescription delivery system 100 according to an exemplary embodiment of the present invention is illustrated in FIG. 1. The system 100 includes several processing components that are located at various physical locations. The various physical locations, which may each have one or more computers or processing devices, are connected via electronic communications, such as the Internet. Multiple computers that are in a single location can be alternatively connected via other electronic communications means. A central component of the system architecture 100 is the Central Service Station (CSS) 102. The CSS 102 maintains databases that contain information used by the exemplary system and administers the operation of the automated prescription delivery system. The CSS 102 is typically maintained at a central or geographically distributed facility that is operated by the provider of the automated prescription delivery system.

Another component of the system architecture 100 is the Point of Care (POC) system 104. The POC system 104 can be operated either in a physician's office or within a Kiosk. A Kiosk that operates the POC System 104 can be located at locations that are conveniently located for patients that can process the transmission of the prescriptions to be filled, such as within a professional building. A POC System 104 that operates in a physician's office is typically used to scan or enter medication prescription information during the patient's visit in which the prescription is written. The POC System 104 of the exemplary embodiment communicates prescription orders for new and refill prescriptions to the CSS 102 via a POC electronic communications interface 110. The CSS 102 has a data input to receive data transmitted by the POC system 104. The exemplary embodiment of the present invention electronically communicates a data set that contains a scanned image of a prescription via the POC electronic communications interface 110. Other embodiments of the present invention can use any of a variety of electronic communications interfaces for the POC electronic communications interface 110, including direct facsimile or other authenticated data transfers. The communications link used by the POC electronic communications interface 110 is able to be any suitable electronic communications interface, such as wired, wireless, satellite or other data communications technique.

The system 100 further contains a Point of Delivery (POD) system 106. The POD system 106 typically operates at a pharmacy that will issue the prescription in the exemplary embodiment. The POD system 106 receives verified and validated prescription orders from the CSS 102 and returns to the CSS 102 status information either indicating that the prescription was delivered or notice that delivery was not possible. The POD system 106 of the exemplary embodiment of the present invention receives the prescription order in the form of a dataset that contains a scanned image of the prescription along with data about the recipient of the prescribed medication, such as the recipient's address, name and other relevant data. Data are communicated between the POD 106 and the CSS 102 via the POD electronic communications interface 112.

The system architecture 100 also contains a Patient Profile Program (PPP) 108. The PPP 108 maintains patient profile data for the system. The PPP 108 of the exemplary embodiment includes a preference input that allows patients to review and modify their profile information, including the patient's demographic and insurance information and preferences in receiving services from the automated prescription delivery system 100. The PPP 108 of the exemplary embodiment allows a patient to view his or her history of prescriptions that were delivered by the system and to also view scanned images of previously entered prescriptions. The PPP 108 of the exemplary embodiment further allows patients to enroll in other system services, such as receiving automatic refill reminders. The PPP 108 of the exemplary embodiment is implemented via a web-based application that allows patients to use this function from any computer with an Internet connection.

The system architecture 100 of the exemplary embodiment includes an interactive voice response (IVR) system 120. The IVR system 120 of the exemplary embodiment is connected to the CSS system 102. The IVR system 120 of the exemplary embodiment is a “text-to-voice” converter that allows software in the CSS system 102 to generate text data that is communicated to the IVR system 120 to be converted into an analog voice signal for output on a telephone connection. The IVR system 120 includes the capability to dial telephone numbers and to output the voice signal onto the telephone line. The IVR system 120 further includes a DTMF decoder that allows interpretation of DTMF codes entered on the telephone by the recipient of the telephone call placed by the IVR system 120. This allows the recipient of the call to provide input to the IVR system 120, which then communicates that input to the CSS 102.

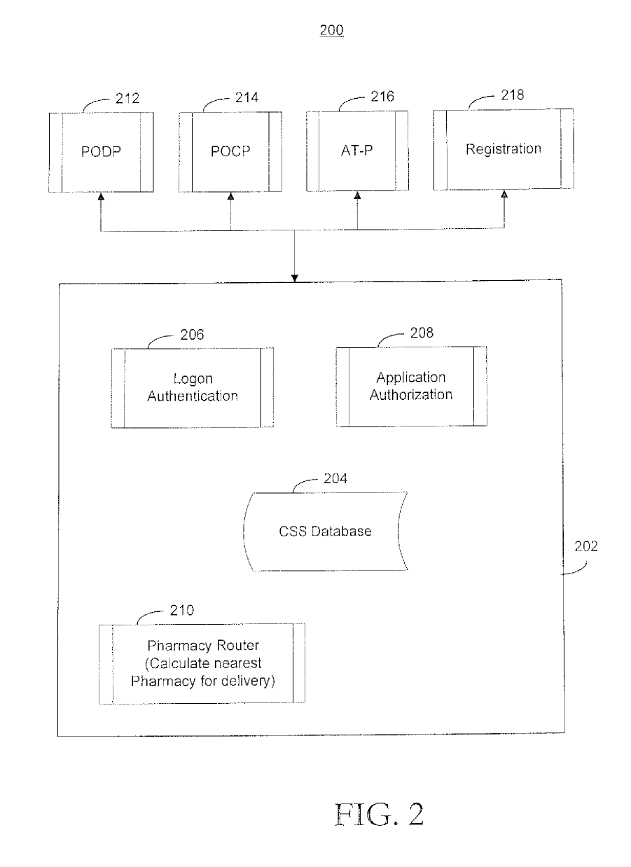

The Software Processing Architecture 200 of the exemplary embodiment is illustrated in FIG. 2. The software processing architecture shows a CSS program 202, which is the processing software that executes on the CSS 102, that consists of several components. The CSS program 202 contains a CSS database 204 that contains pending and issued prescription information, physician account status and other physician information, information concerning patients that are registered with the automated prescription delivery system and other data used in the operation of the automated prescription delivery system. The CSS program 202 has a Logon Authentication component 206 that manages logging on of Point of Care users, such as system users in a physician's office, and the logging on of Point of Delivery users, such as users in a pharmacy. The automated prescription delivery system 100 uses several application programs and access to those application programs is restricted according to the type of user that is attempting to access an application as well as according to the services to which the user subscribes. The Application Authorization component 208 controls access to the various application programs.

The PODP software 212 is the software that operates on a computer associated with the POD system 106. The PODP software 212 performs the processing to allow dispensing of prescribed medication. The PODP software 212 typically operates at a pharmacy and is used by a pharmacist or a pharmacist's assistant.

The POCP software 214 is the software that operates on a computer associated with the POC System 104. The POCP software 214 performs the processing to allow entry of patient data and prescription information. The POCP software 214 typically operates on a computer located either within a Kiosk or in a physician's office. When operating within a Kiosk, the patient is the user of the POCP software 214. When operating on a computer in a physician's office, a physician or a member of the physician's staff operates the POCP software 214.

The Software Processing Architecture 200 contains an AT-P Software Component 216 that provides interfaces for system administrators and for technical support personnel. The system administrator interfaces within the AT-P software component include overall system reporting and management tools. The technical support interfaces include interfaces for technical support personnel to enter new registrations, prescription error recoveries, prescription error re-routing and other operational inputs.

The Software Processing Architecture 200 also contains a Registration software component 218. The Registration software component 218 performs the processing to register patients, physicians, pharmacists and other users of the automated prescription delivery system 100. The Registration software component 218 of the exemplary embodiment of the present invention includes the Point of Care Registration (POCR) component, the Point of Delivery Registration (PODR) component and the Patient Profile Program (PPP) component that each enters and maintains the Point of Care data, Point of Delivery data and Patient personal data, respectively. The registration software component 218 further maintains and allows modification of these registrations. The components of the registration software component 218, as with all of the software components of the automated prescription delivery system 100, are able to operate on separate computers or be distributed over several computers or processors that are interconnected via a communications link. These components are similarly able to operate on parallel processing systems as well as distributed processing systems that use high speed interconnections between multiple processors that are located in proximity to each other.

Patients are able to register to use the automated prescription delivery system 100 by providing their information, such as name, address, payment information and other information used by the system. The exemplary embodiment of the present invention distributes printed information brochures that include a registration form printed on a detachable portion of each brochure. The patient is able to fill in his or her registration data on the registration form with either handwritten or typed information and use this form to register with the system when the patient or other operator of a POC 104 is submitting the patient's first prescription to be filled, as is described below. This provides added convenience to the patient by allowing more impulsive registration and use of the automated prescription delivery system 100.

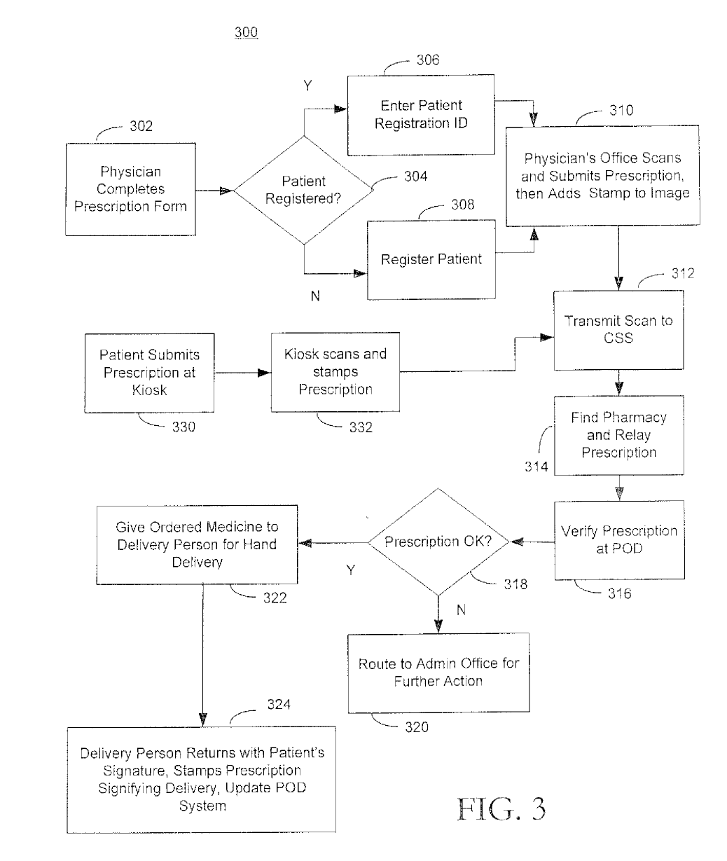

A top level processing flow 300 of the exemplary embodiment of the present invention is illustrated in FIG. 3. The top level processing flow 300 illustrates the processing that is performed by the several components of the automated prescription delivery system 100. The top level processing flow 300 starts with one of two steps depending upon whether the Point of Care (POC) System 104 is within a Kiosk or in a physician's office. If the POC System 104 is within a Kiosk, the processing begins with the patient's submitting, at step 330, the prescription to the equipment within the Kiosk and by the equipment within the Kiosk accepting that prescription. The prescription may be a new prescription issued by a physician or a refill prescription. The prescription is accepted by the Kiosks of the exemplary embodiment by an automatic paper feeder or other image scanner device input that takes the paper prescription and presents the paper to an image scanner. The processing then continues by scanning and stamping, at step 332, the paper prescription that is presented by the patient at the Kiosk. This processing step utilizes an image scanner that is incorporated into the Kiosk to create a digitized image of the paper prescription presented by the patient. The Kiosk processing “stamps” the prescription by adding a digital signature to the scanned image to allow for enhanced validation of the prescription image during later processing at other facilities. The digital signature of the exemplary embodiment includes an indication of the day and time when the prescription was submitted to the system.

Exemplary embodiments of the present invention include Kiosk POC systems 104 that allow the patient to register with the automated prescription delivery system. These Kiosks allow the patient to scan the completed paper registration form along with the prescription form as a single image. This single image is then communicated to the CSS 102 in a process similar to that described below for the physician's office POC system.

If the POC System 104 is in a physician's office, the processing begins instead with the physician completing, at step 302, the prescription form. The prescription can be a new prescription or a prescription for a refill. The processing next determines, at step 304, whether the patient is registered with the automated prescription delivery system 100. The exemplary embodiment of the present invention has the patient tell the physician's office staff whether or not he or she is registered with the system. If the patient is registered, the processing continues with the POCP operator's entering the patient's identification into the POC system 104. The patient's identification in the exemplary embodiment of the present invention is the patient's name and social security number. Alternative embodiments utilize different patient identification techniques, including identification cards encoded with printed or magnetically readable identification numbers or data, biometric identification devices and other identification devices that provide a unique identification of the patient, If the patient is not registered, the processing continues instead by registering the patient, at step 308, by collecting patient information and entering it into the POC system 104 and relaying it to the CSS 102. The patient information can be entered either manually into the POC system 104 or by scanning a form that is completed by the patient, as is described below.

After the patient is either registered or has his or her identification entered into the system, the POCP operator then scans and submits, at step 310, the prescription for the patient. The prescription is scanned by an image scanner that is part of the POC system 104. The POCP processing also adds a digital signature to the scanned prescription image data to indicate that the prescription has been submitted to the automated prescription delivery system 100.

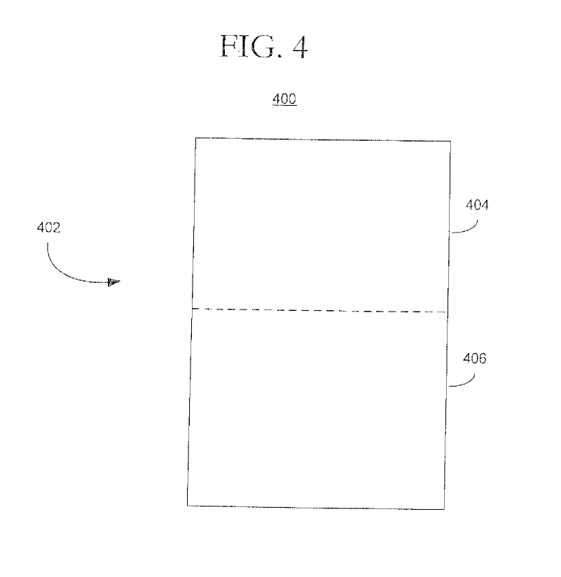

An image scanner face 400 that is utilized by exemplary embodiments of the present invention is illustrated in FIG. 4. The image scanner face 400 is the image scanner window of an image scanner. The image scanner face 400 of the exemplary embodiment is the prescription input and contains a single image scan area 402 that is divided into two sections, the prescription section 406 and the registration data section 404. The prescription form obtained from the physician specifies the medication to be given to the patient and is placed on the prescription section 406. If the patient is registered with the automated prescription delivery system 100, only the prescription form is scanned. In the case of a patient that is not registered with the automated prescription delivery system 100, the registration form that the patient has completed is placed on the registration data section 404, which is the registration data input in the exemplary embodiment, along with the prescription form that is also placed on the prescription section 406. This allows the prescription form and the patient registration data to be simultaneously scanned and a single image to be created that contains the patient's data and the prescription. This single image is then combined with a digital signature and other data, encrypted and electronically transmitted to the CSS 102 for processing. If the patient is registered with the system 100, the POCP operator is only required to enter the patient's name and social security number in order to identify the patient to the CSS 102. The patient's name and social security number are then combined, along with a unique, predetermined set of variables that are configured within the POCP 214, with the image data prior to encryption and transmission.

After the patient has been identified and an electronic image of the prescription has been captured by scanning at either a Kiosk or a physician's office, the image is transmitted, at step 312, to the CSS 102. The exemplary embodiment of the present invention utilizes a combined dataset generator implemented in software to create a combined dataset that contains the prescription image, digital signature and a unique, predetermined set of variables that are configured within the POCP 214 to be combined with the scanned image prior to encryption. The unique, predetermined set of variables is able to include any data, including random data. Inclusion of the unique, predetermined set of variables further increases the difficulty of unauthorized decryption of the data. The exemplary embodiments of the present invention use a data encryption device that is implemented in software and uses ASPEncrypt or SSL to encrypt the datab The exemplary embodiments of the present invention further do not store patient data at the POC system 104. This enhances the security of the data by ensuring that the data is only maintained at a single location, the CSS 102 in the exemplary embodiments. In the exemplary embodiments, the combined image, signature and other data package is communicated among the different computer systems, such as from the POC system 104 to the CSS 102, through use of the conventional Binary Large Object Protocol (BLOP). The BLOP data are included in a conventional e-mail attachment for communications to the CSS 102 in the exemplary embodiments.

The CSS 102 of the exemplary embodiments receives the image and data information transmitted by the POC system 104 and uses a dataset validation device implemented in software that authenticates the received data so as to ensure the legitimacy of the prescription. The authentication in the exemplary embodiment includes operation of a software based identification validation device that verifies that the POC system 104 that transmitted the data is a valid POC system and that the user originating the data is a valid user that is also associated with the particular POC system 104 that sent the data. Once the prescription image is received by the CSS 102, the CSS processing decrypts and validates the data, splits the image data from the other data contained in the encrypted data package, and submits the different data portions for appropriate processing as is described below. The processing of the CSS 102 then finds, at step 314, a pharmacy that is to provide the prescribed medicine to the patient and relays the prescription to that pharmacy. Authentication of the prescription in the exemplary embodiment of the present invention includes verification of a user identification code. The user identification code used in the exemplary embodiment is generated by a software based user identification code generator that combines a physician identification code and a location code. The POC systems 104 of the exemplary embodiments are configured to have a unique location code. This code is configured when the computer is deployed to the POC 104 location. Each POC user is associated with one or more particular POC systems 104 in order to assure proper access to the automated prescription delivery system 100. The POC system 104 stores and transmits to the CSS 102 the user identification code, which is a combination of the physician code and location code, in order to support authentication by the CSS 102. This ensures that the POC operator is associated with the location code of the originating POC system 104.

The pharmacy router 210 of the exemplary embodiment determines a pharmacy or other type of POD 106 that is to deliver the prescription by determining a POD 106 that is registered with the automated prescription delivery system 100 and that was selected by the patient or that is closest to the patient's registered address. The exemplary embodiment allows the patient to select a pharmacy from a list of pharmacies that are registered with the system. In the absence of a selection by the patient, the exemplary embodiment uses a GIS database and the zip code of the patient's address to determine the nearest POD 106. The exemplary embodiment of the present invention selects the same pharmacy for subsequent deliveries to the patient so that the patients prescription originates in one or a few pharmacies in order to facilitate comprehensive screening by a pharmacist of all of the medications that are taken by that patient. Other embodiments of the present invention use other algorithms to find the pharmacy or other POD 106 that is to provide the prescribed medicine. The exemplary embodiment allows the patient to change the selected POD 108 at will via the PPP within the registration component 218.

The CSS 102 uses a software based data encryption device to encrypt a digital data set that contains the image of the prescription and other patient information before transmitting the digital data set to the selected pharmacy. The exemplary embodiments of the present invention transmit other patient information that includes information that is needed to identify the patient, properly bill the patient, and deliver the prescribed medication to the patient. The transmitted patient information is retrieved from the patient profile program (PPP) within the registration component 218. The patient information is alternatively included as image data within the prescription image transmitted to the POD system 106. This alternative is typically used in the case of a newly registered patient whose data has not yet been entered into the PPP.

The prescription data is received at the pharmacy, which has a POD system 106, by the prescription input of the PODP 212 processing component. The prescription input of the exemplary embodiments is an interface to the POD electronic communications interface 112. The prescription image and other data are combined and encrypted for transmission by the CSS 102. The processing at the CSS 102 adds a digital signature to the image prior to encryption and transmission of the data. In the case of refilled prescriptions, an additional digital signature is added to the prescription image stored within the CSS 102 each time the prescription is send to the POD 106 and confirmation of delivery is received from the POD 106, as is described below. This allows tracking of the number of times a refill of that prescription has been provided to the patient. Once the POD system 106 at the pharmacy has received the image of the prescription from the CSS 102, the data are decrypted and the processing continues by using a software based data authenticator to verify, at step 316, the prescription at the POD system 106. This step includes operating a software based digital signature authenticator to ensure that a valid digital signature has been added to the prescription. This step also requires that if the prescription is not refillable, or if the prescription is refillable but the number of digital signatures added to the prescription image is equal to or greater than the number of refills, the operator is to check the order for cancellations of previous submissions to the POD 106. The number of digital signatures added to a prescription image routed to a POD system 106 is checked to ensure that it is less than the total number of refills that a prescription can have. The digital signatures that were added for submissions that had been previously cancelled are not counted. If the last submission had not been cancelled or the prescription is determined to be otherwise invalid, the order is rejected and rerouted, at step 320, back to the central administration office for further action.

If the prescription is verified as OK, the processing continues in the exemplary embodiment by having the pharmacist fill the prescription and enter the prescription data into the pharmacist's existing Pharmacy Management System (PMS). The PMS system assigns the prescription a prescription number, and the pharmacist enters that prescription number and the number of refills into the PODP 216, which then communicates that data back to the CSS 102 with an identification of the prescription. The pharmacist then gives, at step 322, the ordered medicine and a copy of the prescription image to a prescription deliverer, which is a delivery person in the exemplary embodiments, for delivery to the patient. The CSS 102 is notified that the delivery person is in the process of delivering the medication and the status of the prescription is changed to “delivery” within the CSS database 204. The exemplary embodiment further includes providing the delivery person with a “Route Slip” that has printed directions to the patient's address along with the scanned prescription image. The delivery person hand-delivers the medicine to the recipient if and only if the recipient is holding the original copy of the prescription that is identical to the image provided to the delivery person. This ensures that the proper patient gets the medicine and that the medicine is delivered only once. After the medicine is delivered, the delivery person receives, at step 324, the patient's signature to certify a correct delivery. The delivery person can also stamp the original prescription to signify that the medicine specified in that prescription has been delivered and that the prescription has already been filled. The delivery person then returns, also at step 324, to the POD system 106 and the POD operator updates the order status to “Done” in the PODP 212 so that this information is communicated as a confirmation to the CSS 102 and the CSS Database 204. The exemplary embodiment supports status designations of: delivered, no one at the address, prescription mismatch or one of a number of other potential reasons for non-delivery. Embodiments of the present invention provide the delivery person with a wireless communication device that initiates communication of the delivery status immediately upon delivery of the medication to the patient without requiring the delivery person to first return to the POD 106. These devices also include a written signature digitizer that is able to capture and digitize the patient's signature and transmit that image to along with the delivery status.

Embodiments of the present invention allow the pharmacist or staff working under the direction of the pharmacist to establish an electronic communication link to electronically communicate with the physician who wrote the prescription. Communications between the pharmacist and the physician's office in the exemplary embodiments are performed via real-time text communications, such as via instant messaging. Communications between the pharmacy and the physician often involve questions concerning alternative medication that can be given to the patient to better conform to the patient's health plan coverage or to clarify the content of the written prescription. These embodiments allow the pharmacist, or a member of the pharmacist's staff, to attempt to establish a real-time text communications link with the physician's office. A member of the physician's staff is able to accept the communications from the pharmacist, note a question to ask the physician, obtain the answer from the physician and respond to the pharmacist. The physician is also able to partake in the real-time text communications with the pharmacist. If a real-time communications link cannot be established with the physician's office, due to the POC system 104 not being on-line or a lack of response by the staff, the physician is able to send an e-mail to the physician that requests the further information required by the pharmacist.

All checks to make sure that a patient is not allowed to have a prescription filled twice are performed by the exemplary embodiment of the present invention by human operators (e.g., the driver or the POD operator). This further ensures that patients do not receive medication in excess of there prescription and to prevent prescription abuse.

Embodiments of the present invention maintain prescription refill schedule data within the CSS 102 for refillable prescriptions that are fulfilled through the automated prescription distribution system 100. When medicine is delivered to a patient, the CSS 102 of these embodiments includes a medicine quantity input that receives information from the POD system 106 that includes the amount of medication dispensed in this delivery and the date that the medication was delivered to the patient. The prescription image delivered to the CSS 102 from the POC system 104 includes the prescribed dosage of the medication. These data are used by the refill data calculator, which is implemented by the CSS program 202 in the exemplary embodiment, to determine the date when the prescription is next required to be refilled. The date of the next refill is entered into the refill schedule data when the notification of prescription delivery is received by the CSS 102 from the PODP 212. The CSS 102 of these embodiments periodically monitor the refill schedule data to determine when refill dates are approaching and these embodiments then notify the patient of the need to refill the prescription.

Embodiments that notify patients of upcoming prescription refill dates use the Interactive Voice Response (IVR) system 120. The IVR system 120 provides voice messages and entry prompts during a phone call to the patient. The patient is able to respond by pressing number keys on his or her telephone to provide input in response to the voice prompts via DTMF codes generated in response to pressing the keys.

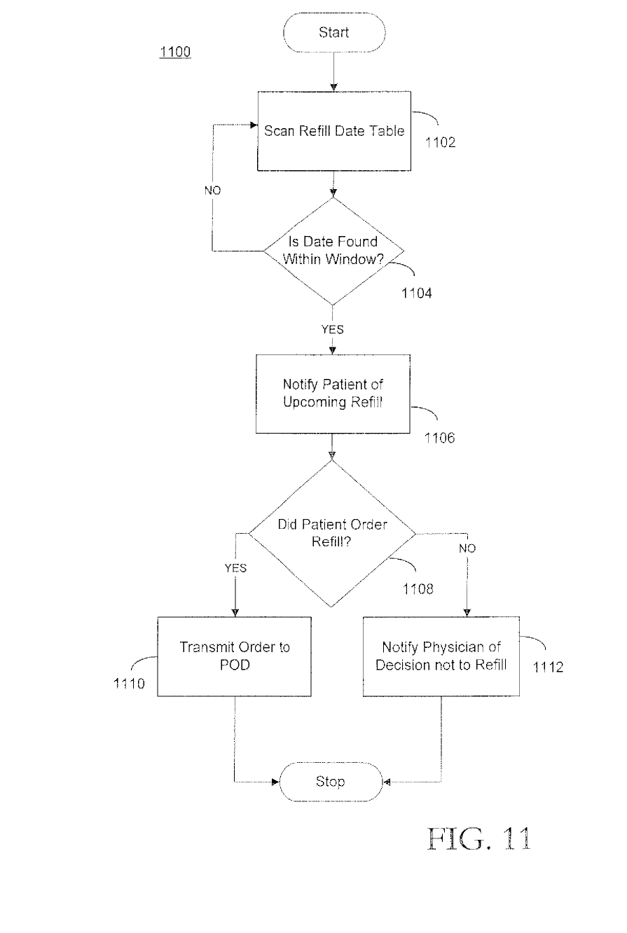

The Refill Notification Processing 1100 performed by exemplary embodiments of the present invention is illustrated in FIG. 11. The refill notification processing 1100 of the exemplary embodiment begins by searching, at step 1102, through the refill date table that is maintained by the CSS 102 in order to determine if a patient has a prescription refill date within the time window for refill notification that was defined for that patient. The exemplary embodiments are configured to execute a batch processing task once per day to scan the refill date table. These embodiments allow the patient to modify his or her preferences regarding refill notification. A patient is able to use the Patient Profile Program (PPP) within the registration component 218 to alter these preferences via interfaces provided, for example, through an Internet web browser or through correspondence with CSS technical support personnel. Patient preferences that are able to be modified by the PPP include the parameters associated with the refill notification processing 1100. One preference that can be set and modified by the PPP of the exemplary embodiment is the number of days prior to a predicted prescription refill date that the patient desires to be notified. Patients are able to specify that a notification phone call, as is described below, is to be made a specified number of days before the refill is predicted to be required. A patient might, for example, use the PPP to specify that he or she is to be notified five days before a predicted prescription refill date.

The processing then determines, at step 1104, if the refill date table contains a date for a refill that is within the notification time period for the patient that is to receive that refill. If there is not a refill date within this time period, the processing returns to scan the refill data table. If there is a date within this time period, the processing then notifies, at step 1106, the patient of the upcoming need to refill the prescription via a patient notifier, which is primarily implemented in software within the CSS program 202. In addition to the software, the patient notifier of these embodiments further utilize the IVR system 120 to automatically call the patient and provide a voice message of the upcoming refill date and ask the patient whether he or she would like to order the refill through the automated prescription delivery system 100. The processing determines, at step 1108, whether the patient chooses to order the refill. If the patient did select to order the refill, the order is submitted to the CSS 102 for routine processing and is transmitted, at step 1110, to the POD system 106. If the patient chooses not to order the refill, the physician is notified, at step 1112, of the patient's choice. This provides the physician with a notice that the patient is not following the prescribed medication usage and allows the physician to contact the patient to discuss this non-compliance.

Point Of Care Program (POCP)

The Point of Care Program (POCP) 214 allows a patient or a staff person in a physician's office to enter a prescription into the electronic prescription delivery system 100. This program receives prescription data from a registered user and sends it to the CSS 102. The prescription data is then routed to the pharmacy or other POD 106 that is to fill and deliver the prescription.

The POCP 214 is operated by two types of users. The first type of user consists of patients, who are the primary user when this module is located within a Kiosk. The second type of users is a physician or other users who are under the direction of a physician, such as physician's assistants, nurses and other physician office workers. This second type of user is the primary user when this module is in a POC 104 that is located in a physician's office. Both of these types of users have access to online prescription ordering through the Internet after a successful login to the system.

The POCP 214 of the exemplary embodiment performs operator interface functions in conjunction with an Internet World Wide Web browser or a simple client application. All connections are done via the conventional HTTPS protocol and no information about the patient or prescription is saved on the computer running this module. The POCP 214 of the exemplary embodiments enforces a set of business rules. These business rules are enforced through the automated nature of the exemplary embodiment of the present invention so that adherence to these rules is automatic and cannot be avoided. An example of the business rules established by the POCP 214 of the exemplary embodiment is the maintenance of an audit trail. The exemplary embodiment of the present invention implement audit trails that log all of the changes that are made as each prescription entry is entered and/or edited.

Validation of Input Fields at Client Entry

The exemplary embodiments of the present invention validate input data as it is entered in the client/browser, Examples of data input into the POCP 214 include patient identification. Patient identification is accepted by an identification input, which is a keyboard or touch screen input in the exemplary embodiments. The exemplary embodiments validate as many of the input fields as is possible, such as empty fields, non-selected drop-down lists and simple email validation. A message is displayed to the user identifying any field found to be in error.

### Server Validation of Data

The following data items that are entered into the POCP 214 of the exemplary embodiment are validated on the CSS 102 after they are received by the CSS 102. If any validation errors are determined, an error message is displayed via the POCP 214 to the user identifying the field or fields in error.

Social Security Number (SSN) Validation The CSS program 202 verifies the SSN for patients who are in the United States of America. Patients with addresses outside of the United States do not generally have an SSN and the CSS program 202 of the exemplary embodiment does not verify this value, thereby allowing blank data in the SSN data field. The CSS program 202 of the exemplary embodiment accepts SSN data and strips any dashes that have been included in that data. Once the SSN data is accepted and dashes have been removed, the data is determined to not be a valid SSN if it matches one of the following patterns:
1) Contains any characters other than the numerals 0-9
2) Doesn't contain exactly nine (9) characters
3) The area or first 3 numbers are 000
   Operating Characteristics of the POCP

The POCP 214 of the exemplary embodiment has a series of pages that are displayed after a successful login of a patient. In these pages, the patient is able to scan his or her new prescription, or choose a previously entered refill prescription and/or change his or her shipping or billing information.

The initial page displayed to the POCP user is the new prescription page. This is the page shown to patient after successful login. The user is then able to scan in a new prescription.

Items Displayed Data On New Prescription Page:

1) Name is displayed as a read only field formatted as first, middle and last name of the patient.

2) Shipping address is displayed as read only and is formatted as the shipping address of the patient.

3) Billing address is displayed as read only and is formatted as the billing address of the patient.

4) Prescription image shows the scanned image of the prescription.

Operator Command Buttons

The following operator command buttons are displayed on the Graphical User Interface (GUI) of the POCP 214.

Change personal info Button: Pressing this button transfers user to patient profile module. He/she is then able to change his/her profile information.

Scan prescription Button: Pressing this button prompts user to put the prescription into the scanner and press OK button (or cancel otherwise). Pressing OK button starts the scanner to scan the prescription and the scanning result will be shown in its place on the page. Pressing Cancel button will cancel the scanning and simply closes the prompt window.

Choose a Refill prescription: Pressing this button transfers user to “Refill Prescription Page”

Send Prescription to Pharmacy: After a successful scanning of a prescription, this button will be enabled. By pressing this button, this module sends the whole prescription image and the patient identity to the CSS 102 via a secure connection.

Logout: Closes the connection to the CSS 102 and logs the patient out.

Video Tutor: Display a video clip to the user explaining the operation of the POCP 214. This option is available on the Kiosk version of the POCP 214 and uses a video display incorporated into the Kiosk.

Language Selection: This allows selection of various languages to be used for operator displays.

Refill Prescription Page: This page is shown to the patient when he/she requests to choose a refill prescription from previously entered prescriptions. In addition to profile information of the patient, there is a table on this page containing the prescriptions associated with this patient. This display implements a refill request input device by allowing a user to select a displayed prescription that is to be refilled. The content of the displayed table is able to be filtered by the date of prescription via a combo box. The default value of the date limit is 60 days.

Data Items Displayed on the Refill Prescription Page:

Name is displayed as read only and is formatted as the first, middle and last name of the patient.

Shipping address is displayed as read only and is formatted as the shipping address of the patient.

Billing address is displayed as read only and is formatted as the billing address of the patient.

Date limit: This is a combo box containing some specific date limits to control the content of the prescriptions tabular. Some choices of this combo box are “last week,” “last month,” “last two months” and “last three months.” Default value of this combo box is “last two months.”

Prescription tabular display: displays the prescription refill data in a tabular form and allows selection of one or more displayed prescriptions.

Operator command Buttons on the New Prescription Page

The following Graphical User Interface (GUI) operator command buttons are displayed on the New Prescription Page.

Change personal info Button: Pressing this button transfers user to patient profile module. He or she is then able to change his or her profile information.

New prescription Button: Pressing this button transfers user to “New Prescription Page”

Choose a Refill prescription: Pressing this button transfers user to “Refill Prescription Page”

Send Prescription to Pharmacy: By pressing this button, the software based refill order transmitter of this module sends the prescription and the patient identity to the CSS 102 via a secure connection. After a prescription is sent, an automatic logout may be performed if the data communications link to the CSS 102 is not continuously available, such as in the case of a dial-up data connection.

Logout: Closes the connection to the CSS 102 and logs the patient out.

Point of Care Program Processing Flow

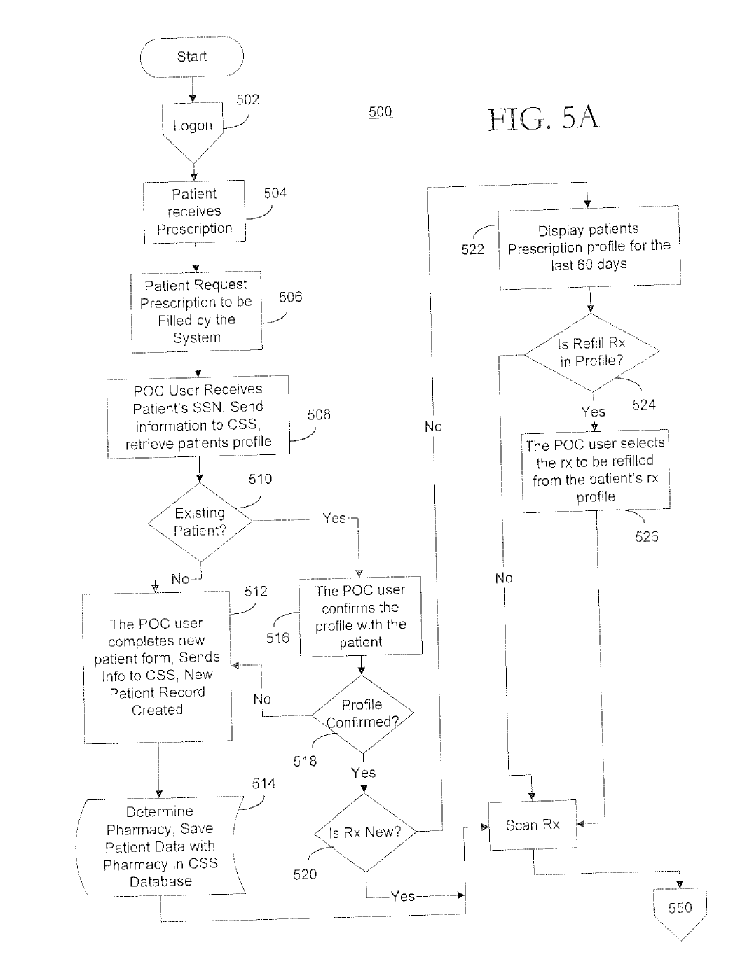

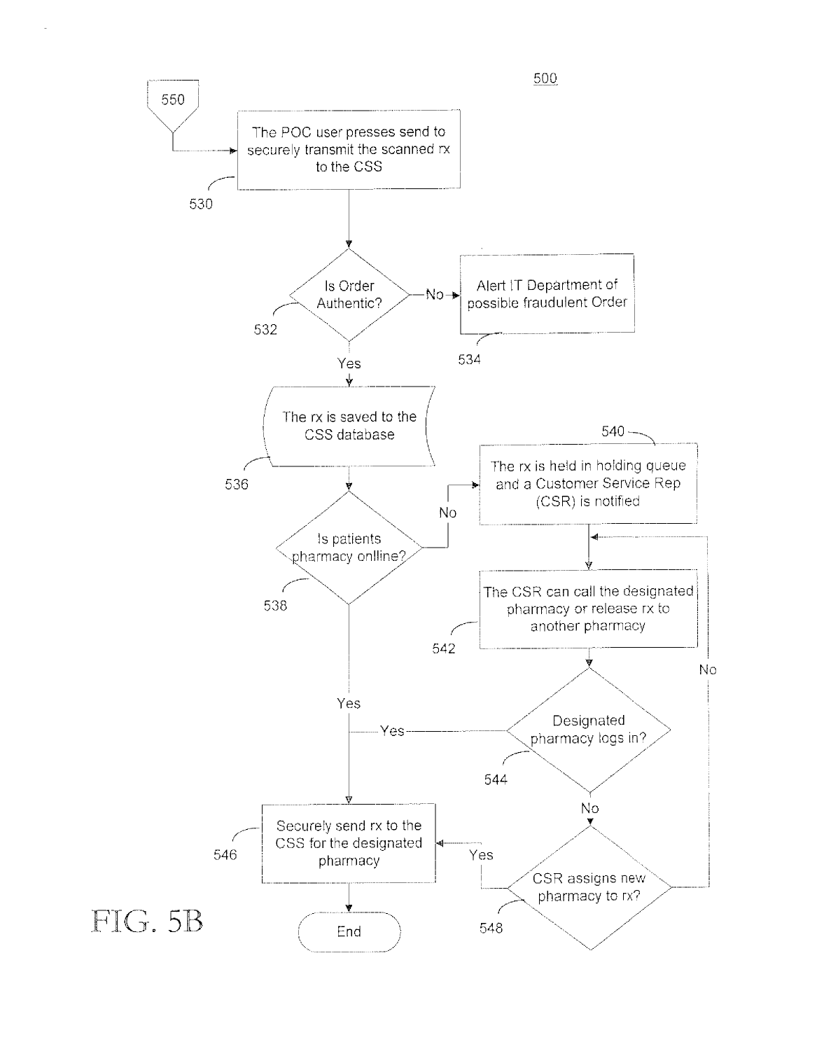

A Point of Care Program (POCP) Processing Flow 500 of the POCP 214 of an exemplary embodiment of the present invention is illustrated in FIGS. 5A and 5B. The Point of Care Program processing flow 500 begins with the logon, at step 502, of a POC user. A POC user is typically a physician or a member of the physician's staff that is associated with a physician's office. The processing then continues with the patient's receipt, at step 504, of a prescription from a physician that is associated with a POC system 104. After the patient receives the prescription, the patient is able to request, at step 506, that the prescription be filled through the automated prescription delivery system 100. The POCP processing 500 then has the POC user ask the patient for his or her user name and Social Security Number (SSN), the identification that is used to uniquely identify the patient within the exemplary embodiment of the automated prescription delivery system 100. Other embodiments utilize different identification data for the patient. The POC user then receives, at step 508, the patient's SSN and enters the patient's data into the POC system 104. The patient's SSN is then communicated to the CSS 102 and the patient's profile is retrieved by the CSS 102.

Once the CSS 102 retrieves the patient's profile, the CSS 102 determines, at step 510, if the entered patient is an existing patient within the CSS database 204. If the patient is not an existing patient, the processing continues by having the POC user complete, at step 512, a new patient form and then transmitting that data to the CSS 102. Once transmitted to the CSS 102, the data is used to create a new patient record within the CSS database 204. The exemplary embodiments of the present invention securely transmit data between the CSS and other systems to ensure the privacy of the patient's records. Once the new patient data record has been created within the CSS database 204, the processing then determines, at step 514, a pharmacy that is to be used to fulfill the prescriptions for this patient. The preferred embodiment of the present invention determines a pharmacy by calculating a pharmacy within the network of pharmacies that participate in the automated prescription delivery system 100 that is closest to the address of the patient. Other embodiments of the present invention use different methods of determining a pharmacy. The processing then saves, also at step 514, the patient data with the determined pharmacy into the CSS database 204.

If the patient was determined to be an existing patient with a profile stored in the CSS database, the processing continues by having the POC user confirming, at step 516, the patient's profile with the patient. If the profile is not confirmed, the processing continues by creating, at step 512, a new patient record as described above. If the patient profile is confirmed, the processing continues by determining, at step 520, whether the prescription, which is indicated by the expression ‘Rx,’ is a new prescription. If the prescription is a new prescription, the processing continues with the POC user scanning, at step 528, the prescription as is described below.

If the prescription is determined to not be a new prescription, the processing continues by displaying, at step 522, the patient's prescription profile for the last 60 days. The exemplary embodiment of the present invention displays the prescription profile for the last 60 days in descending order. The processing then continues, at step 524, by determining if this prescription is a refill. The exemplary embodiment of the present invention determines if the prescription is a refill based upon input by the POCP 214 operator. The exemplary embodiments of the present invention allow a patient using the POCP 214 to select from a list of previously entered prescriptions that have allowable refills remaining. If the prescription is a refill, the processing continues by having the POC user selecting, at step 526, the prescription to be refilled from the displayed patient's prescription profile.

If the prescription is a new prescription, is not a refill prescription or after the prescription to be refilled has been selected, the processing continues with scanning, at step 528, of the prescription by the POC user. After scanning of the prescription, the processing continues, through off-page indicator 550, by having the POC user press, at step 530, the “send” button on the POC system to securely transmit the scanned prescription to the CSS 102. After receipt of the scanned prescription, the CSS 102 determines, at step 532, whether the prescription is authentic. The exemplary embodiments of the present invention determine the authenticity of the prescription by validating the attached digital signature. If the prescription is not authentic, the processing continues by alerting, at step 534, the Information Technology (IT) department of the central administration center of a possibly fraudulent order and no further processing is performed for this prescription. If the prescription is determined to be authentic, the processing continues by saving, at step 536, the prescription into the CSS database 204.

The processing continues by determining, at step 538, if 1) the pharmacy that is to fulfill the prescription is “on-line,” which means that the pharmacy data connection 112 and the POD 106 are operating, 2) there is no response from the pharmacy, or 3) that the pharmacy is not open. If there pharmacy is determined to not be “on-line,” the processing continues by holding, at step 540, the prescription and notifying a customer service representative. The processing then continues with the customer service representative's contacting the pharmacy or releasing the prescription to another pharmacy. The processing then determines, in step 544, whether the designated pharmacy has subsequently “logged in,” and therefore re-established the communications link. If the pharmacy has not logged in, the processing determines, at step 548, whether the customer service representative had assigned a new pharmacy, and if a new pharmacy was not assigned, the prescription is again held and the customer service representative is again notified, at step 542, prior to continuing the processing as is described above.

In addition to not being “on-line,” a pharmacy or other POD may not be able to deliver the medication at the required or requested delivery time. A pharmacy may also be out of inventory of the prescribed medication. The exemplary embodiment of the present invention handles this case by determining an alternative pharmacy or POD 106 to deliver the prescribed medicine and the scanned image of the prescription is rerouted to that pharmacy or POD 106.

If the pharmacy was on-line, if the designated pharmacy logs in or if the customer service representative assigned a new pharmacy, the processing continues by securely sending, at step 546, the prescription to the CSS 102 and designating which pharmacy is to fulfill the prescription. The processing of this prescription within the POCP 214 then terminates.

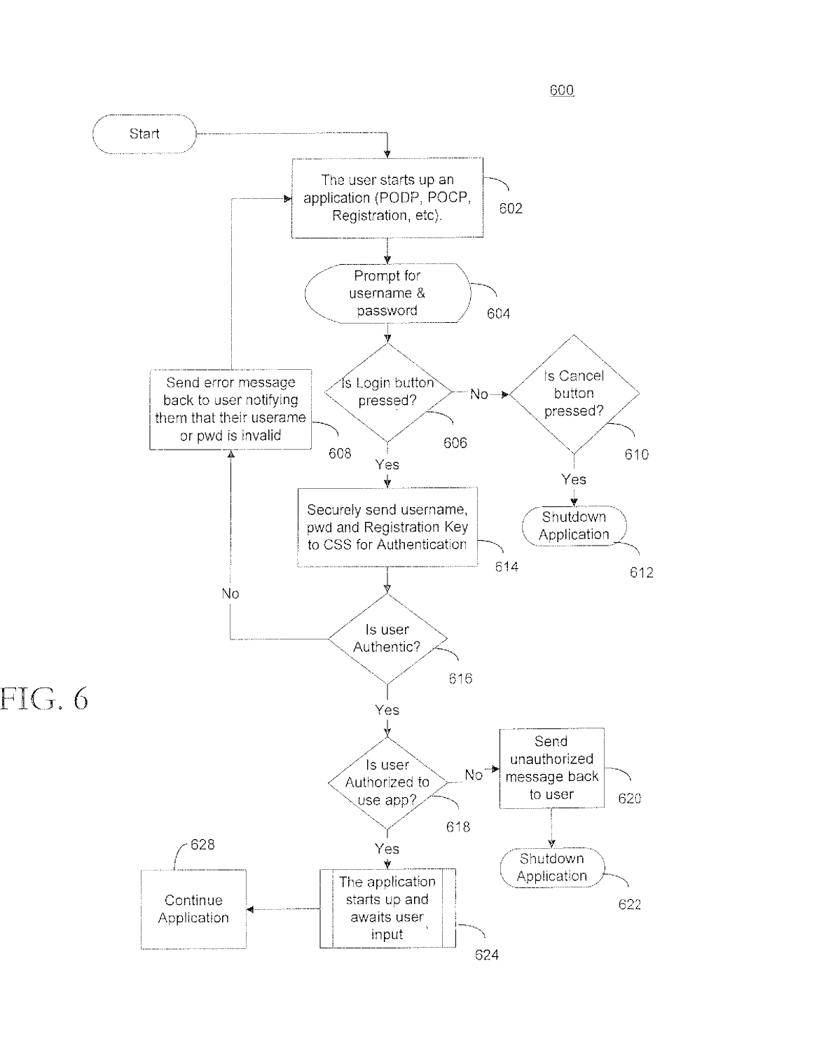

The Logon Processing flow 600 of the exemplary embodiment of the present invention is illustrated in FIG. 6. The logon processing flow 600 is common to several applications used by the exemplary embodiment, including the PODP 212 and the POCP 214. The logon processing flow 600 begins when the user of a particular application starts, at step 602, the application. The exemplary embodiment initiates the start-up processing when the PODP 212, POCP 214 and Registration 218 applications start. After the application is started, the user is prompted, at step 604, for his or her username and password. The processing then determines, at step 606, whether the login button that is displayed by that application has been pressed. If the login button is not pressed, the processing determines, at step 610, if the cancel button is pressed. If the cancel button is pressed, the application is shutdown, at step 612.

If the login button was pressed, the processing continues by securely sending, at step 614, the username, password and registration key to the CSS for authentication. The registration key is a configured parameter associated with the software application that is being started and uniquely identifies the software application and installation facility. The processing then determines, at step 616, if the user is authentic. The exemplary embodiment authenticates a user by checking the supplied Username and password against the user table in the CSS database 204. If the user is determined to be valid. The CSS program 202 generates a new session ID, i.e., a Globally Unique Identifier (GUID) and hash-key. The hash-key in the exemplary embodiment is generated from the GUID. The processing of the exemplary embodiment further gets the user's privileges from the permissions table, stores the GUID hash-key and privileges in a session table, and returns the session ID and hash-key to user so that they can be used for all subsequent application requests. If the generated hash-key does not match the hash-key computed by the server, the request is aborted in the exemplary embodiments. This feature helps filter Denial of Service (DOS) attacks.

If the user is not authentic, the processing continues by sending, at step 608, an error message to the user notifying the user that the entered username and password combination is invalid. If it is not the 3rd failed logon attempt, the error message of the exemplary embodiment contains the message “Invalid username or password try again.” If this is the 3rd failed logon attempt, then the processing of the exemplary embodiment suspends the username and sends an error message back indicating that the username has been suspended.

If the user is determined to have been authentic, the processing continues by determining, at step 618, if the user is authorized to use the started application. If the user is determined to not be authorized, an “unauthorized user” message is sent, at step 620, to the user. This message notifies the user that he or she is not authorized to use the application that has been started. The application is then shutdown, at step 622.

If the user is authorized to use the application, the processing continues by continuing to start, at step 624, the application and await user input. The processing of the particular application that was being started then begins, at step 628.

Physician Registration Module

This module allows a physician to complete an online registration form for access to the automated prescription delivery system 100. This module is part of the Registration module 218. This module is used for entering required physician registration information and does not grant access to the system. Access is granted the system by another module controlled and used by authorized employees. Entries and editing of registration data is tracked via an automated audit trail. This module utilizes an HTTP “web” browser and an HTTPS secure communications link to provide communications security for data communications.

Physicians are the primary users of this automated module. System administrative personnel associated with the operator of the automated prescription delivery system 100 and other users are able to send registration forms via conventional mail, e-mail facsimile and other methods.

Module Operation

Input data is validated in the exemplary embodiment on the client/browser by checked for empty fields, non-selected drop-down lists, simple email validation and other checks. A message is displayed to the user that identifies any fields found to be in error.

The CSS program 202 performs the following validations and if there are any validation errors, an error message is displayed to the user identifying the field or fields in error:

Physician License Number: The Physician License number consists of an alphabetical prefix (used as license type) followed by a number assigned to licensed physician. It is used to identify physician to various payers. Existing Internet data resources are used by the exemplary embodiment to verify the physician license number.

Postal Code Validation by State: Postal Code is validated to confirm that the postal code entered is valid for the state and/or country selected.

DEA Number Validation: The DEA is an alphanumeric string that is currently a number beginning with an A or B that is followed by another letter. The exemplary embodiment of the present invention is configured to accommodate any alphanumeric string so as to allow for DEA numbers that begin with other values. The DEA number in the exemplary embodiment is able to begin with any two alphanumeric characters.

State License Number Validation: The State License Numbers of physicians are validated.

The physician registration module starts by displaying an online registration page that is a single display page that allows a physician to enter data used by the automated prescription delivery system 100. The data includes the physician's name, address, practice information, DEA number, license numbers, e-mail, phone number and web site address. The Physician Account module within the registration module 218 allows qualified users to add additional physicians and other information as well as update any existing account information from their account profile. The online registration page also includes a Practice Name Search Button that is a user command button that causes the sending of the contents of the practice name input box to the CSS 102 for search against the existing practices in the database. This command provides the following results:

Results Returned: The results of the search is displayed in a pop-up box with the ability to select a single practice from the list of practices found. The data displayed on the results page will be Practice Name, Address, and State. If the user selects a practice from the list then the data for that practice is populated in the registration page

No Results Returned: If there are no results returned, then a message is displayed to the user indicating that no practices were found.

Submit Button: This user command button causes client-side validation to be performed.

Responses from Client-side Validation

Error—If any data is missing or invalid an error message will be displayed to the user with any field found to be in error.

No Error—If there are no client-side validation errors then the registration information is sent to the CSS 102 for server-side validation.

Responses from Server-Side Validation

Error—If there is an error validating the data then an error message is displayed to the user indicating the field found to be in error.

No Error—If no error is found, the registration information is saved by the CSS 102 and put into the physician registration queue to be reviewed by an IM Admin user. An email is sent to an alias email address for the IT department notifying them of the newly submitted physician registration. A report identifying all of the new registration forms is available through the web based Administration interface.

Cancel Button: The command button causes a pop-up message to be displayed that asks the user if they really want to cancel. Options within the pop-up message include:

No—causes the display to return to the input page.

Yes—causes redirection to the system's home page.

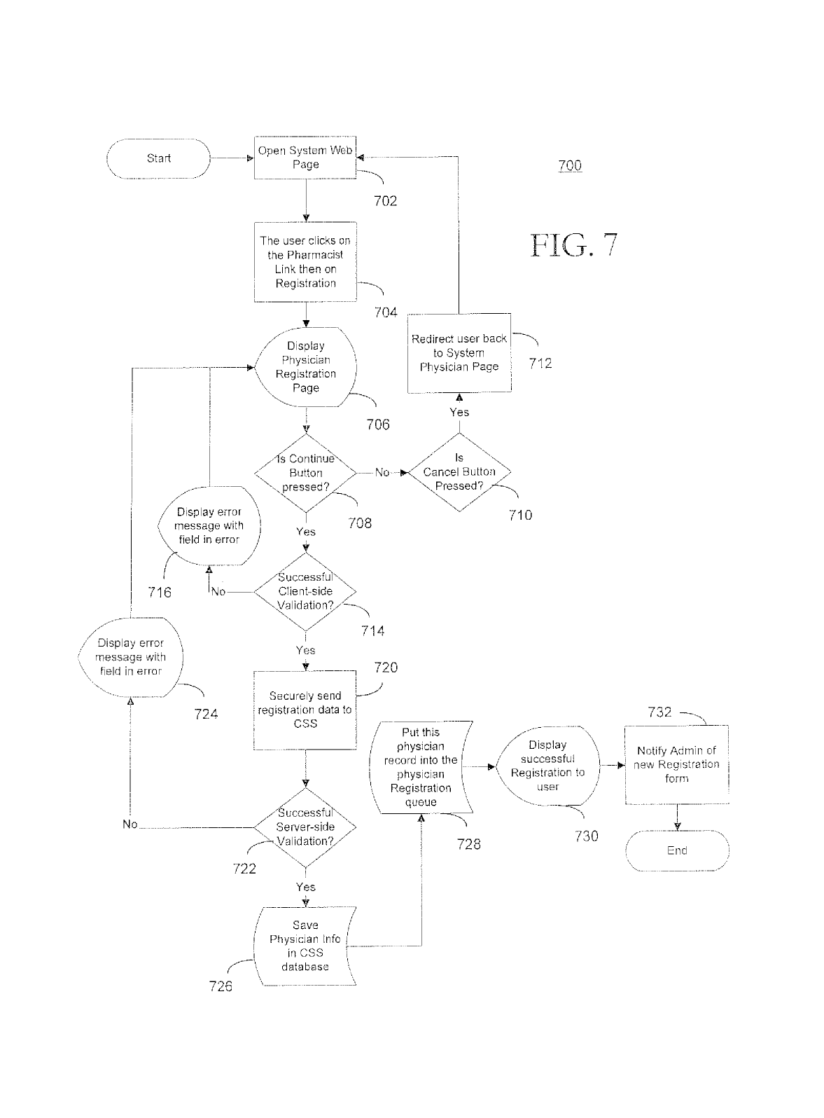

The Physician Registration processing flow 700 of the exemplary embodiment of the present invention is illustrated in FIG. 7. The processing begins when a user, who is a physician, opening, at step 702, the web page associated with the automated prescription delivery system 100. This web page is opened by using any computer with an Internet connection and entering the proper URL for this page. The processing then continues when the user clicks, at step 704, on the “Physician” link and then on the “Registration” link that are displayed on this and a subsequent web page. This causes the “Physician Registration Page” to be displayed, at step 706. This web page allows the user to enter registration information. Once this information is entered, the user is able to press either a “Continue” button or a “Cancel” button, which are Graphical User Interface (GUI) buttons displayed on the web page in the exemplary embodiments. The processing determines, at step 708, if the Continue button is pressed, and if the Continue button is not pressed, the processing determines, at step 710, if the Cancel button is pressed. If the Cancel button is pressed, the processing redirects, at step 712, the user back to the initial Physician Web Page.

If the user pressed the Continue button, the processing determines, at step 714, if there is successful Client-side Validation of the entered data, as is described above. If there is not successful client-side validation, the processing continues by displaying, at step 716, an error message identifying the data field error. The processing then continues by redisplaying, at step 706, the physician registration page.

If there is successful client-side validation of the entered data, the processing then securely sends, at step 720, the registration data to the CSS 102. Once received by the CSS 102, the CSS 102 determines if there is successful server-side (i.e., at the CSS 102) validation of the registration data. If there is not successful server side validation of the registration data, an error message is communicated to the user indicating the field in error. If there is successful server-side validation of the registration data, the processing then saves, at step 726, the physician information into the CSS database 204. After the data is saved, the stored data record is placed, at step 728, into a physician registration queue. A successful registration message is then displayed, at step 730, to the user. The Administrator of the automated prescription delivery system 100 is then notified, at step 732, of the new registration form.

Patient Registration Module

The patient registration module is part of the registration program 218 and is referred to as the Patient Profile Program (PPP) in the exemplary embodiment. The PPP is used to allow a patient to complete an online registration form for access to the automated prescription delivery system 100.

The patient registration module is used by a patient that is registering to use the automated prescription delivery system 100. The exemplary embodiment uses this module to enter all patient registrations. An audit trail of all entered and/or edited data is maintained. Once a patient is registered, an e-mail is sent to the patient's physician notifying the physician of the patient's registration. If the physician does not have an e-mail address on record in the CSS 102, a facsimile or regular mail notification is sent to the physician.

Patients are able to register via a written form or an Internet Web browser interface. Registration by written form is accomplished either via mailing of the written form or scanning of the written form along with the patient's prescription by the POC system 104. Exemplary embodiments that scan the patient's registration information form along with the prescription utilize optical character recognition (OCR) systems to interpret information on the patient registration form and the derived information is entered into the CSS 102.

Exemplary embodiment of the present invention utilizes conventional Internet Web browsers to perform user interface operations. The user interface via this web browser performs client-side validation of user entered data. Client-side validation includes checking for empty fields, non-selected drop-down lists and simple email address validation. A message is displayed to the user identifying the field in error.

Data entered via the user interface is communicated to the CSS 102. The CSS 102 then performs Server-Side Validation of the received data. If there are any validation errors an error message is displayed to the user identifying the field or fields in error. Data fields that are validated during server-side validation include:

Credit Card Validation: Credit card numbers are validated according to rules particular to the credit card types.

Postal Code Validation by State: The postal code that is entered is validated against the state and/or country selected.

Social Security Number Validation: string of characters is determined to be a valid SSN if it matches one of the following patterns (assuming dashes have been stripped):

1) Contains any characters other than the numerals 0-9

2) Doesn't contain exactly nine (9) characters

3) The area or first 3 numbers are 000

Patients outside of the United States are not required to enter social security numbers, and this data is not validated for non-US patients.

Operational Description

An online registration page is a single page that a patient has to complete before submitting their registration. The information entered on this first page generally consists of the information needed to qualify the patient as a user, such as name, billing address and delivery address. The Patient Account module allows qualified users to add additional addresses and phone numbers as well as update any existing account information from their account profile.

User Command Buttons

The user controls operation of this module by pressing Graphical User Interface (GCUI) buttons that are associated with User Commands. Some of these User command buttons are:

Submit Button: This button initiates client-side and server-side validation. Pressing this button produces the output that falls into one of the following categories:

Client Side Error—If any data is missing or invalid an error message will be displayed to the user with the field in question.

Client Side No Error—If there is no client-side validation errors then the registration information will be sent to the CSS 102 for server-side validation.

Responses from Server-side Validation include:

Server Side Error—If there is an error validating the data then an error message will be displayed to the user with the field in question.

Server Side No Error—If there's no error validating then the registration information will be saved to the CSS and put into the patient registration queue to be reviewed by an Administrative user. An email will be sent to an alias email address for the IT department notifying them of the patient registration that was submitted. A report for all of the new registration forms is available through the web based Admin module

Cancel Button: When the Cancel button is pressed, a pop-up message is displayed to the user asking them if they really want to cancel. Two responses are available:

No—this returns the display back to the input page.

Yes—this redirected the display to the system's home page.

Patient Registration Processing Flow

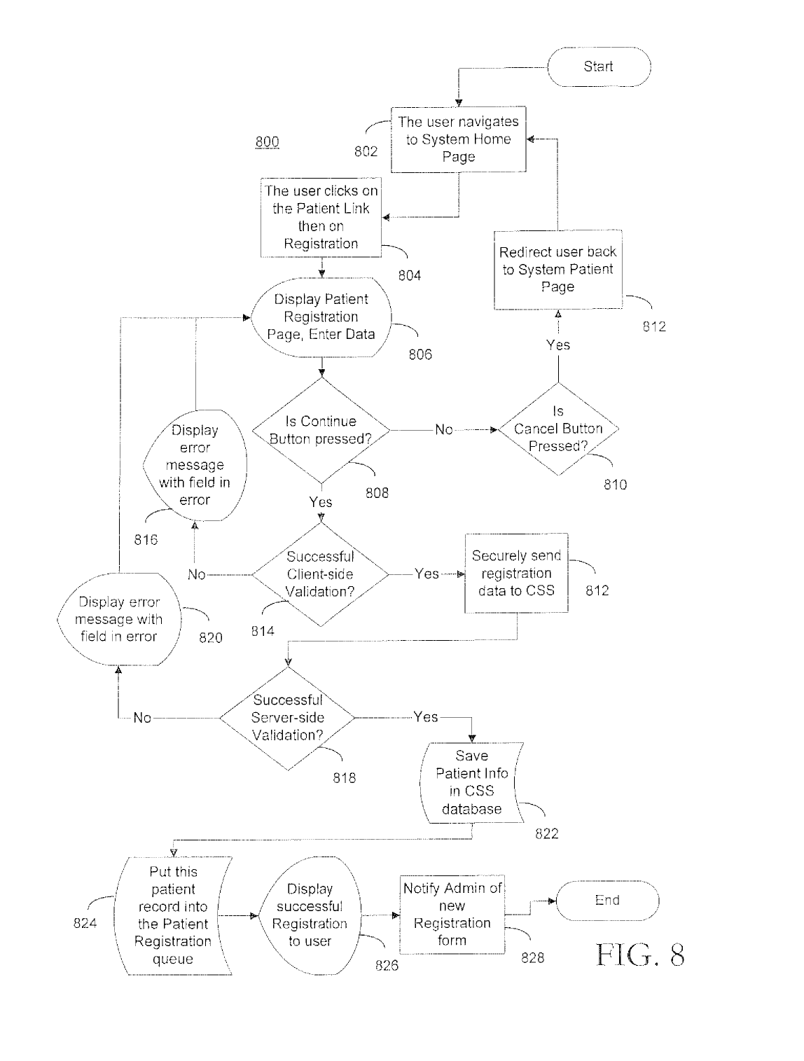

A patient registration processing flow 800 of the exemplary embodiment is illustrated in FIG. 8. The patient registration processing flow 800 beings with the patient using the system navigating, at step 802, to the home web page of the Automated prescription delivery system 100. This step is performed in the exemplary embodiment by using a conventional web browser from a computer with an internet connection, a desktop appliance or a Kiosk machine configured to operate POCP 214 software. Once the patient has the web page for the automated prescription delivery system 100 displayed, the user clicks, at step 804, on the patient and then the registration buttons to select patient registration. This causes the patient registration page to be displayed, at step 806, and allows the patient to enter his or her registration data. Once the patient enters registration data, the processing then determines, at step 808, if the “continue” button of the user GUI is pressed. If “continue” is not pressed, the processing continues by determining, at step 810, if the “cancel” button is pressed. If the cancel button is pressed, the user is redirected, at step 812, back to the patient page for re-entry of patient registration data,

If the “Continue” button was pressed, the processing continues by determining, at step 814, if there is successful client-side validation. If there is not successful client side validation, the processing displays, at step 816, an error message that indicates which field is in error. If there is successful client side validation, the patient registration data is securely sent, at step 812, to the CSS 102. The exemplary embodiment uses an HUPS communications link to securely communicate all data. Once the CSS 102 receives the data, the processing determines, at step 818, if there is successful server-side validation. If there is not successful server-side validation, the processing displays, at step 820, an error message indicating which data field is in error.

If there is successful server side validation, the patient's information is stored, at step 822, into the CSS database 204. The patient's record is then placed, at step 824, into the patient registration queue and a message indicating successful registration is displayed, at step 826, to the user. The administrator of the automated prescription delivery system 100 is then notified, at step 828, of the new registration and processing for the new registration ends.

Pharmacist Registration Module

The pharmacist registration module is used to allow a pharmacist to complete an online registration form for access to the automated prescription delivery system 100. This module is used to enter pharmacist registration information and does not grant access to the system. This module is mainly used by pharmacists to initially register with the system. This module is used to enter all pharmacist registrations in the exemplary embodiment. An audit trail is maintained of all data entered and/or edited.

This module is implemented in conjunction with an Internet Web browser to perform user interface functions. Data entered into fields of the web browser are validated by both programming within the web browser, i.e., Client-Side Validation, and at the CSS 102, i.e., Server-Side Validation. Client-side validation is performed on data input into fields of the client/browser. Validation includes checking for empty fields, non-selected drop-down lists and simple email validation. A message is displayed to the user identifying any field found to be in error. Server-Side Validation is performed once data is communicated to the CSS 102. Examples of the validation that occurs on the CSS 102 are described below. Any validation errors results in an error message that identifies the field or fields in error.

NABP Number Validation: The National Association of Boards of Pharmacy number is a 7-digit numeric identifier assigned to licensed pharmacies. It is used to identify pharmacies to various payers. Its first two digits denote the State, the next four positions are assigned sequentially, and the last position is a check digit.

Postal Code Validation by State: The entered postal code is validated against the state and country selected in other fields.

An online pharmacist's registration page is a single page that a pharmacist completes before submitting their registration. The online pharmacist registration page allows a pharmacist to enter his or her name, address, license data, e-mail address pharmacy web-site, after-hours phone and other data.

User Command Buttons

The GUI of the exemplary embodiment includes User Command Buttons to implement user functions. These buttons allow the pharmacist perform a particular action of submit or cancel their registration. Buttons used by the exemplary embodiment are described below.

Pharmacy Name Search Button: When this button is pressed, the contents of the pharmacy name input box will be sent to the CSS 102 for search against the existing pharmacies in the database. The contents within the input box must be at least 3 characters in length for a valid search.

Results Returned: The results of the search will be displayed in a pop-up box with the ability to select a single pharmacy from the list of pharmacies found. The data displayed on the results page will be Pharmacy Name, NABP Number, and State. If the user selects a pharmacy from the list then the data for that pharmacy wilt be populated in the registration page and the pop-up search page will disappear.

No Results Returned: If there are no results returned then a message is displayed to the user indicating that no pharmacies were found.

Pharmacy NABP Search Button

When this button is pressed the contents of the pharmacy NABP (National Association of Boards of Pharmacy) input box will be sent to the CSS for search against the existing NAPB's in the database. The contents within the input box must be at least 3 characters in length for a valid search.

Results Returned: The results of the search will be displayed in a pop-up box with the ability to select a single pharmacy from the list of pharmacies found. The data displayed on the results page will be Pharmacy Name, NABP Number, and State. If the user selects a pharmacy from the list then the data for that pharmacy will be populated in the registration page and the pop-up search page will disappear.

No Results Returned: If there are no results returned then a message is displayed to the user indicating that no pharmacies were found.

Submit Button: When this button is pressed, the client-side validation will be performed.

Client-Side Validation Results:

Error—If any data is missing or invalid an error message will be displayed to the user with the field in question.

No Error—If there are no client-side validation errors then the registration information will be sent to the CSS 102 server-side validation.

Server-Side Validation Results:

Error—If there is an error validating the data then an error message will be displayed to the user with the field in question.

No Error—If there's no error validating then the registration information will be save to the CSS 102 and put into the patient registration queue to be reviewed by an Administrative user. An email will be sent to an alias email address for the Information Technology department of the system operator notifying them of the patient registration that was submitted. A report for all of the new registration forms is available through the web based Admin module

Cancel Button: When this button is pressed a pop-up message will be displayed to the user asking them if they really want to cancel. Further options are presented, including:

No—If they respond no then bring them back to the input page.

Yes—the user is redirected back to the system's home page.

Exemplary Pharmacist Registration Processing Flow

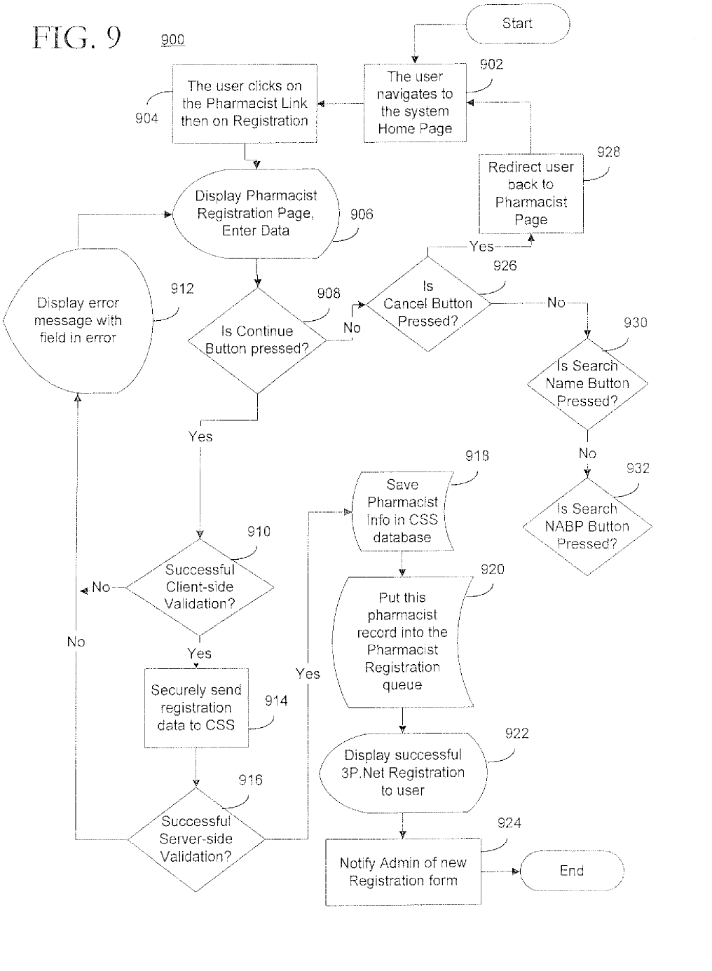

The Pharmacist Registration Processing flow 900 of the exemplary embodiment is illustrated in FIG. 9. The processing beings when the user navigates, at step 902, to the home page for the automated prescription delivery system 100. This is performed with a web browser operating on a computer with internet access. Once the user has the web page for the automated prescription delivery system 100 displayed, the user clicks, at step 904, on the pharmacist and then on the registration buttons to select pharmacist registration. This causes the pharmacist registration page to be displayed, at step 906, and allows the pharmacist to enter his or her registration data. Once the pharmacist enters registration data, the processing then determines, at step 908, if the “continue” button of the user GUI is pressed. If “continue” is not pressed, the processing continues by determining, at step 926, if the “cancel” button is pressed. If the cancel button is pressed, the user is redirected, at step 928, back to the pharmacist page for re-entry of pharmacist registration data. If the cancel button was pressed, the processing then determines, at step 930, whether the “search name” button was pressed and takes appropriate processing steps if it is. If the “Search Name” button was not pressed, then the processing next determines, at step 932, if the “Search NABP” button was pressed and if it is, the NABP is searched.

If the “Continue” button was pressed, the processing continues by determining, at step 910, if there is successful client-side validation. If there is not successful client side validation, the processing displays, at step 812, an error message that indicates which field is in error. If there is successful client side validation, the patient registration data is securely sent, at step 914, to the CSS 102. The exemplary embodiment uses an HTTPS communications link to securely communicate all data. Once the CSS 102 receives the data, the processing determines, at step 917, if there is successful server-side validation. If there is not successful server-side validation, the processing displays, at step 912, an error message indicating which data field is in error.

If there is successful server side validation, the pharmacist's information is stored, at step 918, into the CSS database 204. The pharmacist's record is then placed, at step 920, into the pharmacist's registration queue and a message indicating successful registration is displayed, at step 922, to the user. The administrator of the automated prescription delivery system 100 is then notified, at step 924, of the new registration and processing for the new registration ends.

Point Of Delivery Program (PODP)

The Point of Care Program (PODP) 212 performs the processing at a point of delivery (POD) 106, such as a pharmacy. The pharmacy of the exemplary embodiment uses computer that executes the PODP 212 and a separate computer to operate a conventional Pharmacy Management System (PMS). The PMS used by the pharmacy of the exemplary embodiment allows the pharmacist to automatically interact with health insurance companies and other entities associated with prescription medicine distribution. The PMS used by the pharmacy of the exemplary embodiment provides a prescription number for each prescription delivered by the pharmacy.

The PODP 212 of the exemplary embodiment is operated by a person on the staff of the pharmacy or other POD 106 entity. The computer that operates the PODP 212 is assigned a unique location number that allows identification of the computer system. Each authorized user is also assigned a user identification number to control access to the automated prescription delivery system. The PODP 212 receives prescription images and patient data from the CSS 102, and allows personnel at the POD 106 to manage distribution of prescription medication routed through the automated prescription delivery system.

The PODP 212 of the exemplary embodiment performs operator interface functions in conjunction with an Internet World Wide Web browser or a simple client application. All connections are done via HTTPS and no information about the patient or prescription is saved on the computer running this module. The PODP 212 of the exemplary embodiments enforces a set of business rules. These business rules are enforced through the automated nature of the exemplary embodiment of the present invention so that adherence to these rules is automatic and cannot be avoided. An example of the business rules established by the PODP 212 of the exemplary embodiment is the maintenance of an audit trail. The exemplary embodiment of the present invention implement audit trails that log all of the changes that are made as each prescription entry is filled and/or edited.

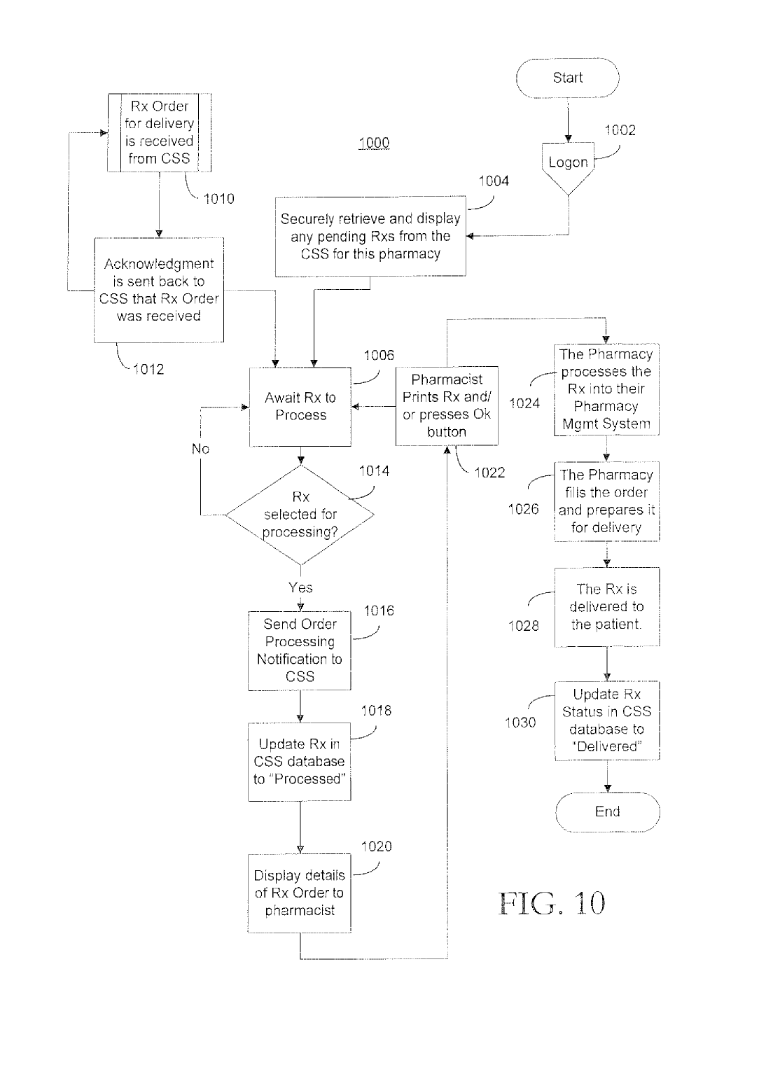

An exemplary PODP processing flow 1000 is illustrated in FIG. 10. The processing of the PODP 212 begins with an authorized user logging in, at step 1002. The login procedure in the exemplary embodiment includes entry of the user's identification name or number and his or her password. Alternative embodiments utilize key cards, biometrics or other techniques to facilitate logging in. Once the PODP user is logged in, the processing retrieves, at step 1004, any prescriptions that are queued within the CSS 102 that are to be delivered by this pharmacy. Once the queued prescriptions are retrieved from the CSS 102, they are internally queued within the PODP 212 and processing continues as is described below.

In the continuous operation of the PODP 212, orders for prescription medication that is to be delivered by this POD 106 are received from the CSS 102. These orders are received, at step 1010, when they are transmitted by the CSS 102, as is described above. In response to the receipt of an order for prescription medication, the PODP 212 transmits, at step 1012, an acknowledgement to the CSS 102 that the order was received. The order data is also internally queued for processing by the PODP 212 and processing continues as is described below. After transmission of an acknowledgement to the CSS 102, the processing then waits for the receipt of another prescription medication order.

Prescription medication orders that are downloaded or received from the CSS 102 are processed with similar processing steps. The processing waits, at step 1006, for a prescription medication order to process. Once a prescription medication order is received, the operator of the PODP 212 selects, at step 1014, a prescription to process. The internal queue of prescriptions received by the PODP 212 is displayed by the exemplary embodiment in a graphical user interface (GUI) that allows the operator to view the internally queued prescriptions and to select a prescription to process. If a prescription is selected for processing, the processing transmits, at step 1016, a notification to the CSS 102 that the order is being processed. The CSS 102 then updates the status of the prescription in the CSS database 204 to “processed,” which indicates that the prescription is being filled by the pharmacist and is being prepared for delivery. The processing then displays, at step 1020, the details of the delivery order to the pharmacist or other operator of the PODP 212 who is working under the direction of the pharmacist. The displayed details include the specification of medication to include, as well as the delivery instructions for the medication.

After the details of the prescription are displayed, the pharmacist, or staff person working under the pharmacist's direction, prints, at step 1022, the prescription and selects the “OK button via the PODP GUI. After the prescription is printed, the processing continues to wait, at step 1006, for a prescription medication order to process. After printing the prescription, the pharmacist then processes the prescription into the conventional Pharmacy Management System (PMS) used by the POD 106 of the exemplary embodiment. The PMS of the exemplary embodiment provides a prescription number that uniquely identifies this prescription order. The exemplary embodiment of the present invention allows the operator of the PODP 212 to enter this prescription number, along with other information including the date the prescription is filled, the actual amount of medication delivered to the patient and the refill number of this delivery if the prescription is refillable. This information is then communicated to the CSS 102 and this information is stored in the CSS database 204.

After the prescription is printed, the pharmacist prepares, at step 1026, the prescribed medication. Once the prescribed medication is prepared, the prescription is then delivered to the patient. After delivery of the prescription, the status of the prescription is updated, at step 1030, to “delivered” as is described above.

It is important to note, that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and visa versa with no loss of generality.

The processing descriptions described above are able to be divided among multiple processors or combined within common processors. The above description distributes and concentrates functions in the processors used in this example in order to simplify the description of these embodiments of the present invention. The processes defined above are able to be distributed among various processors or combined in processors in an architecture that differs from the structure described above.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A method for issuing, filling and delivering prescriptions comprising the steps of:
a. establishing a central service station that includes a physician table, a pharmacy table, a pharmacist table, a patient table and a permissions table;
b. establishing a point of care having capability for converting paper documents to digital equivalents, said point of care comprised of one of a physician's office and a kiosk and including a point of care protocol for transmitting data to the central service station without storing any transmitted data at the point of care except that necessary to show an audit trail;
c. establishing first real-time communication between the point of care and the central service station;
d. establishing a point of delivery comprised of a pharmacy for filling prescriptions and including a Pharmacist Management System for communicating with third parties in the health field with respect to data and verification, and a point of delivery protocol that transmits data from the point of delivery to the central service station without storing any transmitted data at the point of delivery except that necessary to show an audit trail;
e. establishing second real-time communication between the point of delivery and the central service station;
f. establishing a registration protocol for physicians, a registration protocol for patients and a pharmacy and pharmacist registration protocol for storage at the central service station;
g. establishing a manual deliverer for manual delivery of filled prescriptions from the point of delivery to a patient;
h. establishing third real-time communication between the manual deliverer and the point of delivery;
i. creating a written prescription by a physician registered with the central service station for a patient registered with the central service station, and giving the original of the prescription to the registered patient;
j. communicating via said first real time communication from point of care to the central service station the written prescription in digital form together with an authenticating stamp without storing at the point of care any transmitted information except to leave an audit trail;
k. validating at the central service station the validity of the communicated prescription;
l. selecting by the central service station a point of delivery registered pharmacy closest to the registered patient or designated by the registered patient;
m. communicating via said second real time communication to the selected point of delivery registered pharmacy the prescription to be filled together with an authenticating stamp;
n. filling the prescription by the point of delivery registered pharmacy and delivering to a manual deliverer for delivery to the registered patient together with a regenerated copy of the original written prescription;
o. delivering the filled prescription to the registered patient if the registered patient can produce the original of the prescription received from the registered physician that matches the copy of the prescription and signs for the delivery;
p. communicating via said third real time communication by the manual deliverer to one of the point of delivery and the central service station data indicative of the delivery of the prescription to the registered patient, signature and an authenticating stamp.

2. The method for issuing, filling and delivering prescriptions according to claim 1 wherein the creation of the digital form of the written prescription is by scanning,

3. The method for issuing, filling and delivering prescriptions according to claim 1, wherein step j, comprises the step of creating a combined data set that comprises patient identification, data representing the prescription, data representing one of a physician and a location, a digital signature and a unique, predetermined set of variables constituting the authenticating stamp; step m comprises the step of creating a combined data set that comprises patient identification, data representing the prescription, a digital signature and a unique, predetermined set of variables constituting the authenticating stamp; and step p comprises the step of creating a combined data set that comprises patient identification and address for delivery, data representing the prescription, data representing a patient signature and a unique, predetermined set of variables constituting the authenticating stamp.

4. The method for issuing, filling and delivering prescriptions according to claim 1, wherein each combined data set is encrypted.

5. The method for issuing, filling and delivering prescriptions according to claim 1, wherein a request for refill is transmitted to the central station, processed for validation, and a prescription is delivered via the manual deliver in accordance with steps o and p.

6. The method for issuing, filling and delivering prescriptions according to claim 5, wherein the request for refill is determined via an interactive voice response system.

7. A system for issuing, filling and delivering prescriptions comprising:
a. means for establishing a central service station that includes a physician table, a pharmacy table, a pharmacist table, a patient table and a permissions table;
b. means for establishing a point of care having capability for converting paper documents to digital equivalents, said point of care comprised of one of a physician's office and a kiosk and including a point of care protocol for transmitting data to the central service station without storing any transmitted data at the point of care except that necessary to show an audit trail;
c. means for establishing first real-time communication between the point of care and the central service station;
d. means for establishing a point of delivery comprised of a pharmacy for filling prescriptions and including a Pharmacist Management System for communicating with third parties in the health field with respect to data and verification, and a point of delivery protocol that transmits data from the point of delivery to the central service station without storing any transmitted data at the point of delivery except that necessary to show an audit trail;
e. means for establishing second real-time communication between the point of delivery and the central service station;
f. means for establishing a registration protocol for physicians, a registration protocol for patients and a pharmacy and pharmacist registration protocol for storage at the central service station;
g. means for establishing a manual deliverer for manual delivery of filled prescriptions from the point of delivery to a patient;
h. means for establishing third real-time communication between the manual deliverer and the point of delivery;
i. means for creating a written prescription by a physician registered with the central service station for a patient registered with the central service station, and giving the original of the prescription to the registered patient;
j. first means for communicating via said first real time communication from point of care to the central service station the written prescription in digital form together with an authenticating stamp without storing at the point of care any transmitted information except to leave an audit trail;
k. means for validating at the central service station the validity of the communicated prescription;
l. means for selecting by the central service station a point of delivery registered pharmacy closest to the registered patient or designated by the registered patient;
m. second means for communicating via said second real time communication to the selected point of delivery registered pharmacy the prescription to be filled together with an authenticating stamp;
n. means for filling the prescription by the point of delivery registered pharmacy and delivering to a manual deliverer for delivery to the registered patient together with a regenerated copy of the original written prescription;
o. means for delivering the filled prescription to the registered patient if the registered patient can produce the original of the prescription received from the registered physician that matches the copy of the prescription and signs for the delivery;
p. third means for communicating via said third real time communication by the manual deliverer to one of the point of delivery and the central service station data indicative of the delivery of the prescription to the registered patient, signature and an authenticating stamp.

8. The system for issuing, filling and delivering prescriptions according to claim 7 means for scanning to create the digital form of the written prescription.

9. The system for issuing, filling and delivering prescriptions according to claim 7, wherein the first means for communicating includes creating a first combined data set that comprises patient identification, data representing the prescription, data representing one of a physician and a location, a digital signature and a unique, predetermined set of variables constituting the authenticating stamp; the second means for communicating includes creating a second combined data set that comprises patient identification, data representing the prescription, a digital signature and a unique, predetermined set of variables constituting the authenticating stamp; and the third means for communicating includes creating a third combined data set that comprises patient identification and address for delivery, data representing the prescription, data representing a patient signature and a unique, predetermined set of variables constituting the authenticating stamp.

10. The method for issuing, filling and delivering prescriptions according to claim 9, wherein each combined data set is encrypted.

11. The system for issuing, filling and delivering prescriptions according to claim 7, means for generating a request for refill, transmitting to the central station, processing for validation, and means for delivery the refilled prescription via the manual deliverer.

12. The system for issuing, filling and delivering prescriptions according to claim 1 1, further including an interactive voice response system to generate the request for refill.

13. A computer readable media containing programming instructions, the media comprising programming instructions for: issuing, filling and delivering prescriptions by establishment of a central service station that includes a physician table, a pharmacy table, a pharmacist table, a patient table and a permissions table; establishment of a point of care having capability for converting paper documents to digital equivalents, and including a point of care protocol for transmitting data to the central service station without storing any transmitted data at the point of care except that necessary to show an audit trail; establishment of first real-time communication between the point of care and the central service station; establishment of a point of delivery comprised of a pharmacy for filling prescriptions and including a Pharmacist Management System for communicating with third parties in the health field with respect to data and verification, and a point of delivery protocol that transmits data from the point of delivery to the central service station without storing any transmitted data at the point of delivery except that necessary to show an audit trail; establishment of second real-time communication between the point of delivery and the central service station; establishment of a registration protocol for physicians, a registration protocol for patients and a pharmacy and pharmacist registration protocol for storage at the central service station; establishment of a manual delivery system for manual delivery of filled prescriptions from the point of delivery to a patient, establishment of third real-time communication between a manual deliverer and the point of delivery; communication via said first real time communication from point of care to the central service station including a written prescription issued by a physician registered with the central service station for a patient registered with the central service station in digital form together with an authenticating stamp without storing at the point of care any transmitted information except to leave an audit trail; validation at the central service station of the validity of the communicated prescription; selection by the central service station of a point of delivery registered pharmacy closest to the registered patient or designated by the registered patient; communication via said second real time communication to the selected point of delivery registered pharmacy of the prescription to be filled together with an authenticating stamp; for delivery of the filled prescription to a manual deliverer for delivery to the registered patient together with a regenerated copy of the original written prescription; and communication via said third real time communication by the manual deliverer to one of the point of delivery and the central service station data indicative of the delivery of the prescription to the registered patient including the registered patient having produced the original of the prescription received from the registered physician that matches the copy of the prescription and has signed for the delivery and an authenticating stamp.

14. A computer readable media containing programming instructions according to claim 13 including an instruction to accept creation of the digital form of the written prescription by scanning.

15. A computer readable media containing programming instructions according to claim 13, wherein the instruction for first communication includes creation of a combined data set that comprises patient identification, data representing the prescription, data representing one of a physician and a location, a digital signature and a unique, predetermined set of variables constituting the authenticating stamp; the instruction for second communication includes creation of a combined data set that comprises patient identification, data representing the prescription, a digital signature and a unique, predetermined set of variables constituting the authenticating stamp; and the instruction for third communication includes creation of a combined data set that comprises patient identification and address for delivery, data representing the prescription, data representing a patient signature and a unique, predetermined set of variables constituting the authenticating stamp.

16. A computer readable media containing programming instructions according to claim 15, further including instructions for encryption of each combined data set.

17. A computer readable media containing programming instructions according to claim 13, further including instructions for transmission of a request for refill to the central station for processing for validation, and for refilling the prescription for delivery via a manual deliver.

18. A computer readable media containing programming instructions according to claim 17, including further instructions for use of an interactive voice response system to generate the request for refill.
